(19) United States
(12) Patent Application Publication
(10) Pub. No.: US 2019/0180725 A1
(43) Pub. Date: Jun. 13, 2019

(54) DIGITAL SOUND EFFECT SYSTEM

(71) Applicants: George GAUSE, Beverly Hills, CA (US); Nathan Daniel VILLICANA-SHAW, San Pablo, CA (US)

(72) Inventors: George GAUSE, Beverly Hills, CA (US); Nathan Daniel VILLICANA-SHAW, San Pablo, CA (US)

(21) Appl. No.: 16/218,083

(22) Filed: Dec. 12, 2018

Related U.S. Application Data
(60) Provisional application No. 62/597,831, filed on Dec. 12, 2017.

(51) Int. Cl. G10H 1/00

(52) U.S. Cl. CPC G10H 1/0091; G10H 2210/195; G10H 2210/066; G10H 1/0008

(57) ABSTRACT

A process includes collecting a digital input signal and performing initial pitch detection to detect one or more pitches on the digital input signal. The process also includes manipulating the digital input signal to form a manipulated digital signal based on the one or more pitches detected.

### CROSS-REFERENCE TO RELATED APPLICATIONS

The present application claims priority from U.S. Provisional Patent Application No. 62/597,831, filed on Dec. 12, 2017, the entirety of which is incorporated herein by reference.

### TECHNICAL FIELD/FIELD OF THE DISCLOSURE

The present disclosure relates generally to controlling manipulated sounds from stringed instruments and other acoustic instruments equipped with a pickup or microphone.

### BACKGROUND OF THE DISCLOSURE

Modern instrumental performances often involve the use of peripheral equipment that allows the user to extend the sound palette of a stringed instrument or other acoustic instrument. A stringed instrument may be an electrical stringed instrument or an acoustic stringed instrument with an electric pickup. Non-limiting examples of stringed instruments include, but are not limited to, Appalachian dulcimer, auto-harp, banjo, bazantar, bass, chapman stick, clavinet, cello, diddley bow, fiddle, guitalele, guitar (including bass, electric, flamenco, Hawaiian, standard acoustic, and twelve string), guitar zither, harp guitar, octofone, octobass, pedal steel guitar, psaltery, resophonic guitar, steel guitar, strumstick, violin, viola, ukulele, and zither.

Stringed instruments may be equipped with a transducer, known traditionally as a pickup (either built-in or attached as a peripheral) or a microphone. Other acoustic instruments may be equipped similarly with a pickup or a microphone.

Personal computers and other computers offer extensibility and additional tools (such as effects, processors, looping, and recording). The manipulation of real-time audio and pre-recorded audio is included in many styles of music. Manipulation of such audio may require physically altering the recording medium. Manipulation of audio may also require additional hardware to create or play the manipulated audio. Current hardware is complicated and hard to use, creating a barrier to exploring the sonic possibilities of audio manipulation, both in the studio and in live settings.

Computers often suffer on-stage computer crashes, distracting interfaces, and technical difficulties, any of which may delay or end a performance. On a computer, dozens of software applications other than a digital audio workstation (DAW) may run concurrently. Such software applications may interfere with performance of the DAW and result in changes in speed and memory performance of the computer. Further, the DAW for hosting digital audio effects programs is a large and resource-heavy application. Computers typically require a performer both to look at a computer screen and to use the performer's hands for precise actions, which, when performing, can be difficult and lead to mistakes by the performer.

### SUMMARY

The present disclosure includes collecting a digital input signal and performing initial pitch detection to detect one or more pitches on the digital input signal. The process also includes manipulating the digital input signal to form a manipulated digital signal based on the one or more pitches detected and outputting an audio signal based on the manipulated digital signal.

The present disclosure also includes a method of manipulating an analog signal from an instrument. The method includes accepting an analog audio signal from an instrument through an audio input device and transmitting the analog audio signal to a pre-amp to form a pre-amp signal output. In addition, the method includes transmitting the pre-amp signal output to an analog-to-digital converter to form a digital input signal and transmitting the digital input signal to a processor. The method also includes performing pitch detection and frequency analysis with the processor on the digital input signal and forming a manipulated digital signal using the processor. Further, the method includes transmitting the manipulated digital signal to a digital-to-analog converter and converting the manipulated digital signal to an analog processed signal using the digital-to-analog converter. The method includes transmitting the analog processed signal to an output pre-amp to adjust the output gain or volume of the analog processed signal to form a processed amp signal and transmitting the processed amp signal to a post-effects device to form an audio output signal.

In addition, the present disclosure includes a sampler. The sampler includes an audio input device, a switch, the switch in analog communication with the audio input device, and a post-effects device, the post effects device in analog communication with the switch. The sampler also includes a pre-amp, the pre-amp in analog communication with the switch and an analog-to-digital converter in analog communication with the pre-amp. In addition, the sampler includes a processor, the processor in digital communication with the analog-digital converter and a digital-to-analog converter in digital communication with the processor and in analog communication with the post-effects device. The sampler further includes an audio output device, the audio output device in digital communication with the post-effects device.

### BRIEF DESCRIPTION OF THE DRAWINGS

The present disclosure is best understood from the following detailed description when read with the accompanying figures. Various features are not drawn to scale. The dimensions of the various features may be arbitrarily increased or reduced for clarity of discussion.

FIG. 1 is a schematic diagram of a digital sound effect system consistent with at least one embodiment of the present disclosure.

FIG. 2 is a flow diagram of a process consistent with at least one embodiment of the present disclosure.

FIG. 3 is a schematic diagram of a digital sound effect system consistent with at least one embodiment of the present disclosure.

FIG. 4 is a flow diagram of a process consistent with at least one embodiment of the present disclosure.

FIG. 5 is a top view of a digital sound effect system consistent with at least one embodiment of the present disclosure.

FIG. 6 is a rear view of the digital sound effect system of FIG. 5.

FIG. 7 is a perspective view of the digital sound effect system of FIG. 5.

FIG. 8 is a flow diagram of a process consistent with at least one embodiment of the present disclosure.

FIG. 9 is a flow diagram of a repitch synthesis operation consistent with at least one embodiment of the present disclosure.

FIG. 10 is a flow diagram of an FM synthesis operation consistent with at least one embodiment of the present disclosure.

FIG. 11 is a flow diagram of an AM synthesis operation consistent with at least one embodiment of the present disclosure.

FIG. 12 is a flow diagram of a spectral match operation consistent with at least one embodiment of the present disclosure.

FIG. 13 is a flow diagram of a spectral mix operation consistent with at least one embodiment of the present disclosure.

FIG. 14 is a flow diagram of a physical model operation consistent with at least one embodiment of the present disclosure.

### DETAILED DESCRIPTION

The following disclosure provides many different embodiments, or examples, for implementing different features of various embodiments. Specific examples of components and arrangements are described to simplify the present disclosure. These examples are, of course, merely examples and are not intended to be limiting. In addition, the present disclosure may repeat reference numerals or letters in the various examples. This repetition is for the purpose of simplicity and clarity and does not dictate a relationship between the various embodiments or configurations discussed.

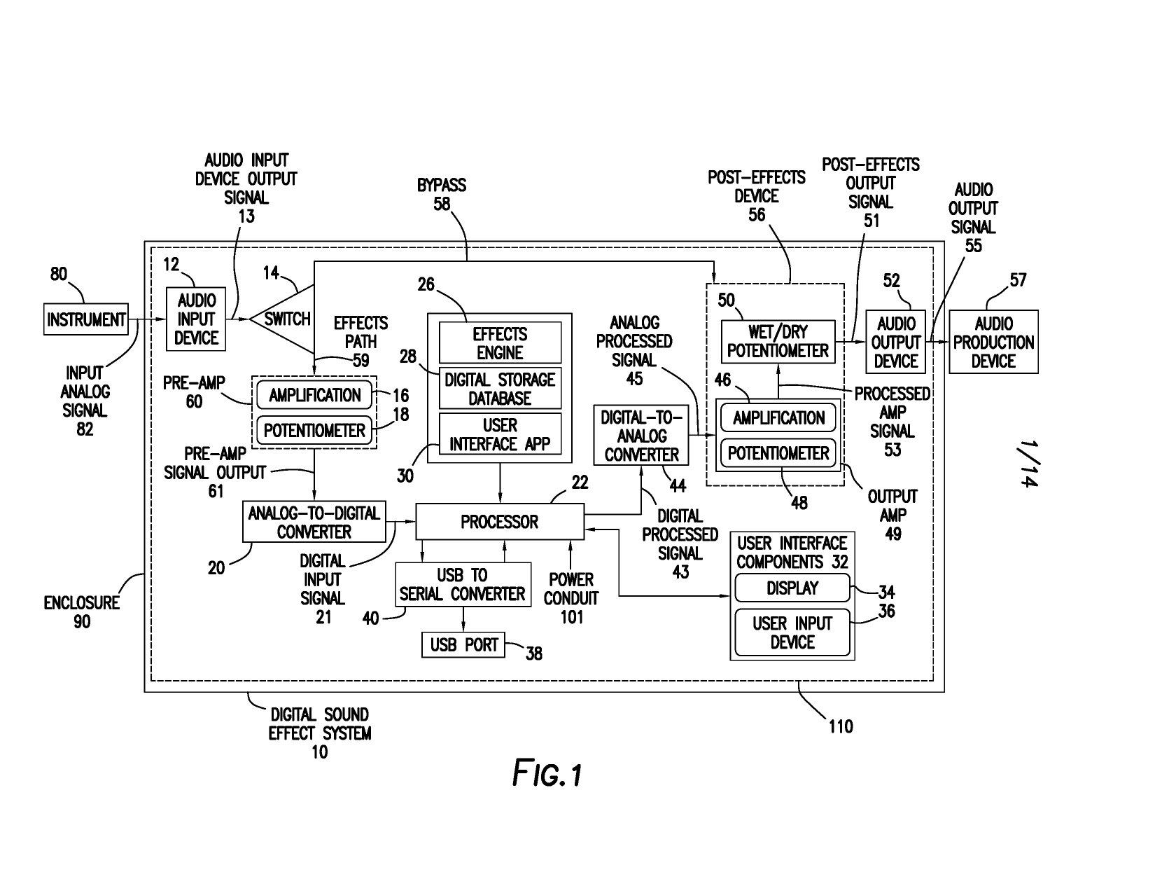

FIG. 1 is a schematic diagram of digital sound effect system 10. Digital sound effect system 10 allows a user to manipulate or substitute sounds from a stringed instrument or other acoustic instrument or from an effects pedal with sounds from other sound sources. Digital sound effect system 10 permits a spectrum of modification of sounds from direct non-tonal to tuning and blending stored digital audio files with input digital audio signals. Digital sound effect system 10 creates the potential for performers to use recorded sounds, including, but not limited to, sounds of nature, urbanity, or other sounds and transform the recorded sounds into a musical context of various forms.

Digital sound effect system 10 may include sampler 110. Sampler 110 may be standalone and dedicated hardware that, for example and without limitation, receives an analog signal, transforms the analog signal to a digital signal, analyzes the digital signal, manipulates or substitutes for the digital signal, and transforms the manipulated or substituted digital signal into an analog signal.

In some embodiments, sampler 110 may be contained in enclosure 90, such as a box or enclosed case. In some of these embodiments, digital storage database 28, as described below may be contained within enclosure 90. In other embodiments, digital storage database 28 may be located external to enclosure 90. When digital storage database 28 is located outside of enclosure 90, processor 22 may connect to digital storage database 28 through a port in enclosure 90. In certain embodiments, power may be supplied to sampler 110 through power conduit 101.

In certain embodiments, sampler 110 is mounted on the stringed instrument or other acoustic instrument. In certain embodiments, sampler 110 is not mounted on the stringed instrument or other acoustic instrument. For example, when sampler 110 is not mounted on the stringed or other acoustic instruments, sampler 110 may be an effects pedal, typically a foot pedal. An effects pedal may be easy to use and integrate easily into pre-existing performance practices. Further, an effects pedal does not require the use of the performer's hands for activation or deactivation, and does not require the user's visual attention while using during a performance.

Sampler 110 may accept input analog audio signal 82 from instrument 80 through audio input device 12. As used herein, instrument 80 includes stringed instruments, other acoustic instruments, or a different effects pedal. Audio input device 12 may be, for example and without limitation, a ¼ inch jack, an audio jack, a Tiny Telephone, an XLR, or an optical jack. Audio input device 12 may be directly or indirectly connected to a pickup or microphone associated with instrument 80. Input analog audio signal 82 may have a small voltage and instrument 80 may be in wired connection to audio input device 12. Audio input device 12 may send audio input device output signal 13 to switch 14.

As depicted in FIG. 1, in some embodiments of the present disclosure, sampler 110 may include switch 14. Switch 14 allows a user to direct a signal associated with instrument 80 directly to post-effects device 56, to processor 22 for manipulation, or both. When switch 14 is disengaged, audio input device output signal 13 is transmitted via bypass 58 to post-effects device 56. When switch 14 is engaged, audio input device output signal 13 is transmitted via effects path 59 to pre-amp 60. Switch 14 may be a latched switch, such as a push button switch. In certain embodiments switch 14 may be a three pole double throw switch (3PDT) or double pole double throw switch (“DPDT”), a momentary normally open pushbutton/foot-switch, or any foot-switch used by performers. Post-effects output signal 51 may be transmitted to audio output device 52. Audio output device 52 may be, for example and without limitation, a ¼ inch jack, an audio jack, a Tiny Telephone, an XLR, or an optical jack. Audio output signal 55 from audio output device 52 may be transmitted to audio production device 57, which may be a different effects pedal, an amplifier, a recording device, or any device that accepts an analog audio signal.

When switch 14 is engaged, switch 14 transmits audio input device output signal 13 via effects path 59 to pre-amp 60. Pre-amp 60 may include operational amplifier (op-amp 16) and potentiometer 18 (for input gain attenuation). Pre-amp 60 may transmit pre-amp signal output 61 to analog-to-digital converter 20.

Analog-to-digital converter 20 may convert pre-amp signal output 61 from an analog voltage to a digital value by reading the voltage at a predetermined sampling rate (the number of samples of audio carried per second). This process is known as “sampling.” Sampling involves taking snapshots of the input analog audio signal at short intervals, usually measured in microseconds. The quality of the digital signal is determined largely by the sampling rate and the bit rate at which the signal is sampled. In certain embodiments, the user may control the size and length of the samples using, for example, user interface 32 (as described hereinbelow). Common sampling rates in audio range from 22 kHz to 192 kHz. In certain embodiments, a user may choose a specific sampling rate based on hardware limitations and the user's preferred configuration. The size of the digital values, or bit-depth, of the sampled signal (the number of bits of information in each sample digital audio file) commonly ranges from 8-24 bits per sample. The example sampling rates and bit-depth are not limiting in scope of the present disclosure. The output of analog-to-digital converter 20 is a continuous digital signal.

Analog-to-digital converter 20 may then transmit the continuous digital signal via digital input signal 21 to processor 22. Processor 22 may be a computer processing unit and non-transitory computer readable media, such as one or more solid state drives (SSD) in the form of internal storage, or external storage, such as a Secure Data card (SD Card), and may include one or more random-access memory devices (RAM, DRAM, SRAM, or other devices).

Processor 22 may include digital storage database 28 stored on the non-transitory computer-readable media. Digital storage database 28 may include stored digital audio files. The stored digital audio files may be in such non-limiting formats as WAV, AIFF, AU, raw header-less PCM, FLAC, Monkey's Audio WavPack, TTA, ATRAC Advanced Lossless, ALAC, MPEG-4 SLS, MPEG-4 ALS, MPEG-4 DST, Windows Media Audio Lossless, and Shorten, Opus, MP3, Vorbis, Musepack, AAC, ATRAC or Windows Media Audio Lossy.

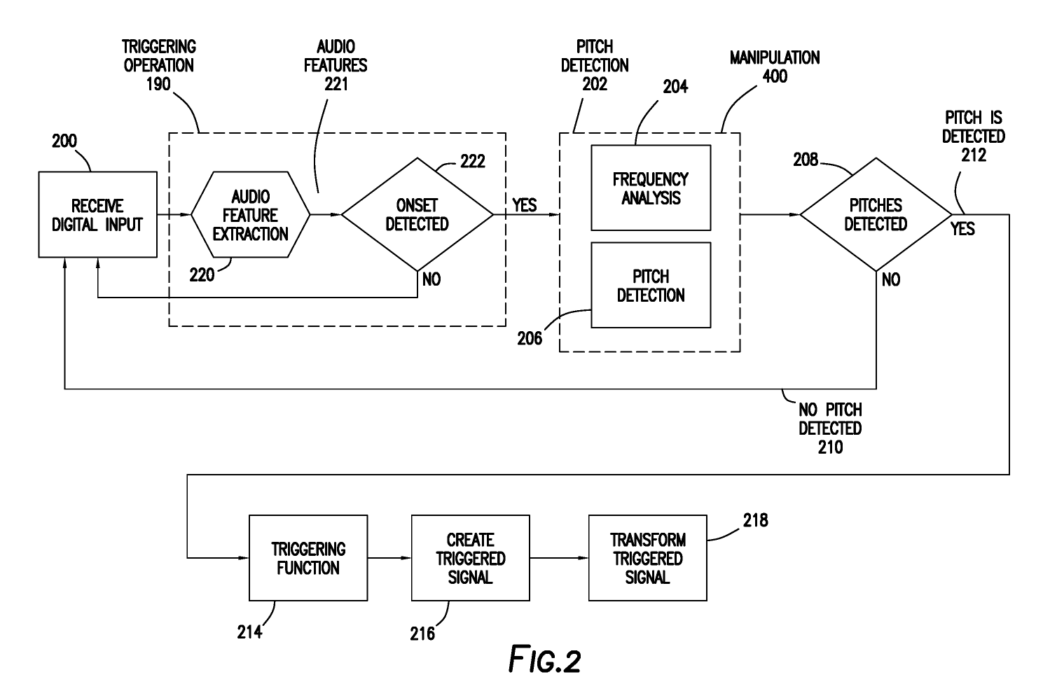

Processor 22 may also include effects engine 26. Effects engine 26 may be computer-readable code capable of being executed by processor 22, such as a software program. Effects engine 26 may perform onset-detection, pitch-detection, audio feature extraction in both the time and frequency domains, and frequency analysis to achieve one of the several desired effects as shown in FIG. 2 and described below. Effects engine 26 may then create a manipulated digital signal, which may be a continuous digital signal. A manipulated digital signal is a digital input signal that has been substituted for or altered by the properties of a stored digital audio file. In some embodiments, the spectral and temporal properties of the stored digital audio file, also known as a sample, may facilitate the manipulation of the digital signal as further discussed below.

Processor 22 may include a user interface application 30 that includes computer readable code capable of being executed by processor 22, such as a software program. User interface application 30 may output a user interface to display 34 to permit a user to interact with user interface 32 through user input device 36. In some embodiments of the present disclosure, user interface application 30 receives input from user input device 36 and communicates the input to effects engine 26. User interface application 30 may also communicate other information and data, such as storage availability, device or program status messages, or visual representations of audio, to display 34.

As depicted in FIG. 1, in some embodiments of the present disclosure, user interface 32 may include display 34 and user input device 36. User interface 32 may be positioned within enclosure 90, as shown in FIG. 1 or separate from the enclosure. Display 34 may be one or more digital displays (LCD, LED, TFT, or OLED). User input device 36 may be, for example and without limitation, a touch screen, keyboard, joystick, or mouse. In certain embodiments, user input device 36 may include a graphical user interface. Through user input device 36, a user may access, configure, save, delete, and recall various parameters of effects engine 26, including but not limited to pitch-detection and frequency analysis. Through user input device 36, a user may map stored digital audio files in digital storage database 28 to pitch. Through user input device 36, a user may access, configure, save, delete, and recall various parameters of the style of output sample manipulation. Through user input device 36, a user may access, configure, save, delete, and recall various parameters of analog-to-digital converter 20, digital-to-analog converter 44, user interface application 30, and other system configurations available by the included hardware. Pitch-to-sample configurations can be saved as “patches” for easy recall and switching between other saved configurations, or “presets.”

As depicted in FIG. 1, in some embodiments of the present disclosure, digital sound effect system 10 may include one or more USB ports 38. USB port 38 allows a user to connect to digital sound effect system 10 through other devices, such as a personal computer, giving the user the ability to access digital storage database 28 to add, remove, or alter stored digital audio files. In some embodiments of the present disclosure, a supplementary application running on a personal computer may communicate with digital sound effect system 10 via USB port 38, so as to access, configure, save, delete, and recall various parameters of the digital sound effect system 10, similar to that described for user input device 36. In some embodiments, USB port 38 may connect to a storage device such as a hard drive or flash drive to, for example and without limitation, allow digital sound effect system 10 to access additional stored digital audio files or to import additional stored digital audio files onto digital sound effect system 10. In some embodiments, digital sound effect system 10 may include one or more USB-to-serial converters 40. In such embodiments, USB port 38 may be in electrical communication with processor 22 via USB-to-serial converter 40.

Processor 22 may transmit the manipulated digital signal from processor 22 to digital-to-analog converter 44 using digital processed signal 43. Digital-to-analog converter 44 converts digital signal from processor 22 to an analog signal, which is transmitted to output pre-amp 49 through analog processed signal 45. Digital-to-analog converter 44 may be separate from analog-to-digital converter 20, or digital-to-analog converter 44 and analog-to-digital converter 20 may be a combination Stereo Audio Codec that performs analog to digital and digital to analog conversion.

Output pre-amp 49 may include op-amp 46 and potentiometer 48. In certain embodiments, op-amp 46 may be a dual op-amp having a plurality of buffers. Output pre-amp 49 may represent a gain stage allowing the user to adjust the output gain/volume of the manipulated analog audio signal, such as through user interface 32. Output pre-amp 49 may transmit processed amp signal 53 to post-effects device 56. Potentiometer 48 allows control over the output gain/volume. In certain embodiments, potentiometer 48 is a knob.

Post-effects device 56 may include wet/dry blend control potentiometer 50; in certain embodiments, wet/dry blend control potentiometer 50 may be a dual linear potentiometer. Post-effects device 56 allows a performer to blend audio input device output signal 13 transmitted via bypass 58 with analog processed signal 45 using wet/dry blend control potentiometer 50 to control how much of each signal is used in the blend. The blending may be achieved by using a dual linear potentiometer, for post-effects device 56, and a dual op-amp 46. Wiring one buffer of dual op-amp 46 for analog processed signal 45 and the other buffer of dual op-amp 46 to audio input device output signal 13 transmitted via bypass 58, then sending those two buffers to the dual linear potentiometer of wet/dry blend control potentiometer 50 will allow blending of the two signals.

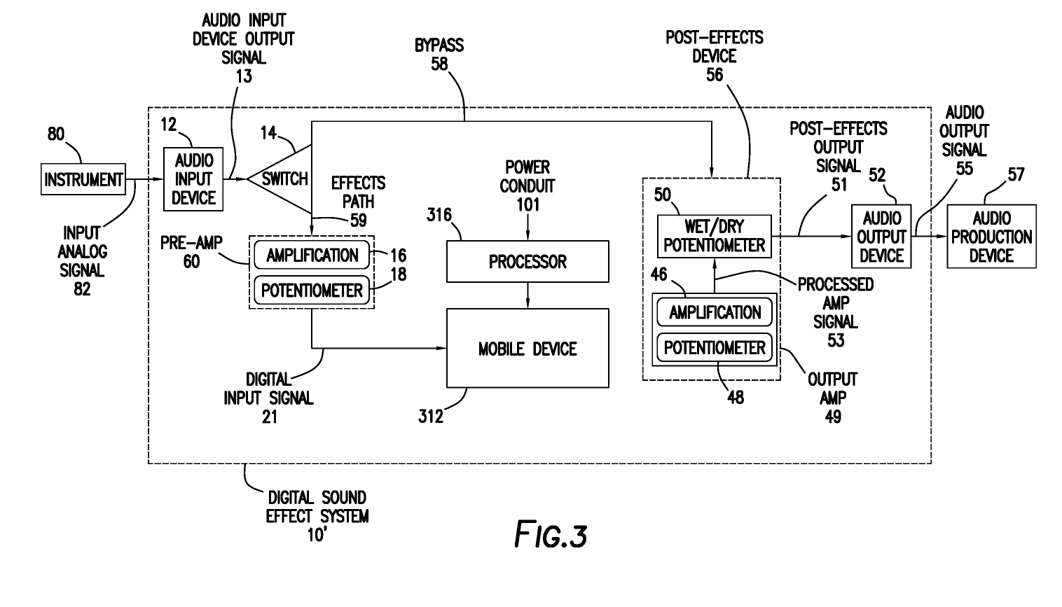

FIG. 3 is a schematic diagram of digital sound effect system 10′ consistent with at least some embodiments of the present disclosure. Digital sound effect system 10′ may include mobile device 312. Mobile device 312 may be, without limitation, a smartphone or tablet. Digital sound effect system 10′ differs from digital sound effect system 10 in at least that mobile device 312 includes the functionality of analog-to-digital converter 20, USB port 38, USB-to-serial converter 40, digital-to-analog converter 44 and combinations thereof. Pre-amp 60 may transmit digital input signal 21 to mobile device 312.

Mobile device 312 may include onboard processor 316 that may include a CPU and memory as described above with respect to processor 22. Onboard processor 316 may include digital storage database 28 stored on non-transitory computer-readable media. Digital storage database 28 may include stored digital audio files. Onboard processor 316 may also include effects engine 26. Effects engine 26 may be computer-readable code capable of being executed by processor 22, such as a software program. Effects engine 26 may perform onset-detection, pitch-detection, and frequency analysis to achieve one of several desired effects as shown in FIG. 2 and described below.

Onboard processor 316 may include a user interface application 30 that may be computer-readable code capable of being executed by onboard processor 316, such as a software program. User interface application 30 may output a user interface to display 34 to permit a user to interact with user interface 32 through user input device 36. In some embodiments of the present disclosure, user interface application 30 receives input from user input device 36 and communicates the input to the effects engine 26. User interface application 30 may also communicate other information and data, such as storage availability, device or program status messages, or visual representations of audio, to display 34.

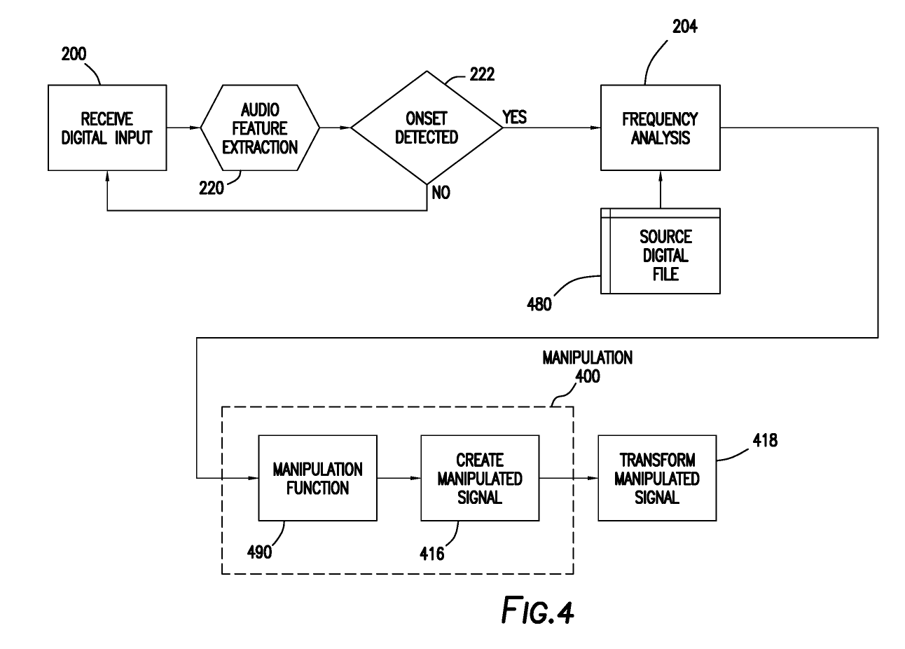

FIGS. 2 and 4 are flowcharts of actions performed by effects engine 26. Effects engine 26 may perform triggering operation 190, as shown in FIG. 2, manipulation operation 400, as shown in FIG. 4, or a combination thereof. In both triggering and manipulation, effects engine 26 receives digital input signal (step 200) from analog-to-digital converter 20. As part of receive digital input signal (step 200), digital input signal is received by effects engine 26 as an audio buffer. To extract the frequency information from the audio buffer, effects engine 26 may split the digital input signal into smaller groups or chunks of audio. Such a process operates as a window that moves over the audio buffer, exposing a predetermined amount of information for processing. The window moves over the audio by “hopping,” meaning the window increments window placement on the audio buffer many samples at a time. Often, the “hop size” is smaller than the “window size,” which results in “overlapping windows.” Some of the audio samples are analyzed multiple times as the window passes over the audio buffer. In certain embodiments, audio samples may be grouped.

Effects engine 26 may be configured to be monophonic, wherein effects engine 26 functions based on the dominant pitch, or polyphonic, wherein effects engine 26 functions using multiple pitches. In certain embodiments, wherein effects engine is polyphonic, the number of pitches used may be set by a user, such as through user interface application 30.

As shown in FIG. 2, when performing triggering operation 190, effects engine 26 may perform initial audio feature extraction (step 220) followed by onset detection (step 222) to recognize when an audio event occurs. If an onset is detected, effects engine 26 may perform initial pitch detection on the digital input signal (step 202). Initial pitch detection may include frequency analysis (step 204); audio feature extraction such as spectral centroid, spectral rolloff, and spectral flux (step 220); and pitch detection (step 206). In audio feature extraction (step 220), a Fourier analysis, using a fast Fourier transform (FFT) or short-time Fourier transform (STFT), of the digital input signal may be performed to convert the digital input signal from the time domain to the frequency domain, resulting in audio features 221. This conversion results in a collection of frequency ranges, or bins, and values that correspond to the level of activity in each bin. Further in frequency analysis (step 204), effects engine 26 determines the dominant frequencies and, from the frequency, the pitch or pitches. In pitch detection (step 206), effects engine 26 may compare the spectral distribution of the digital input signal to determine whether the digital input signal has a dominant frequency that corresponds to a pitch (step 208) played by the user or not, for instance, noise or silence. If initial pitch detection step 202 detects a pitch (212), then the pitch or pitches are subject to triggering and/or manipulation (step 214). If initial pitch detection step 202 does not detect a pitch (step 210), the analysis is optionally dropped (not shown in FIG. 2) or stored to be passed back into initial pitch detection step 202 (as shown in FIG. 2).

Effects engine 26 may perform triggering (step 214). Triggering (step 214) may include many different functions and configurations depending on user settings entered through user input device 36. Depending on the user's selections, triggering (step 214) may use the detected pitch (monophonic) or pitches (polyphonic) to trigger and re-synthesize one or more stored digital audio files. Effects engine 26 may map specific stored digital audio files to specific pitches or pitch ranges, for example, A4 (commonly tuned to 440 Hz), or generally to all pitch classes, for example to all Cs disregarding octave shifts. Effects engine 26 may trigger one or more stored digital audio files for each pitch or range of pitches and pitch map those stored digital audio files based on an initial root pitch value. Through configuration, the user may select all pitches or a range of pitches to map to one or more audio files and for each audio file, a root pitch. While not all audio files have a single discrete pitch, such as noise or a musical phrase that contains many pitches, the selection of an initial root pitch determines how the audio file will be mapped to the input pitches. The user may select an initial root pitch through, for example, user interface application 30. After the file selections with initial root pitch values are set, effects engine 26 will map the stored audio file's pitch relative to the input pitch. For example and without limitation, if the input pitch is A5=880 Hz and the initial root pitch for the stored digital audio file was set by the user at A4=440 Hz, the stored digital audio file will be pitch-shifted up one octave. In certain embodiments, pitch-shifting may be achieved by altering the playback speed of the stored digital audio file. Aspects of playback may include speed, direction, looping (for example, forward, backward, forward then backwards, with settable loop points), and tuning. In such embodiments, the playback speed of the stored digital audio file may be determined by the ratio of the input pitch and the initial root pitch. In other embodiments, where a range of pitches is selected by the user, pitch mapping may be performed over that range of pitches. Other ranges of pitches may be mapped differently. The pitch-mapping results in the creation of a triggered digital audio signal (step 216). After creating triggered digital audio signal (step 216), effects engine 26 may transform the triggered digital audio signal to the time domain (step 218) by way of an inverse fast Fourier transform (IFFT) so that the triggered digital audio signal can be converted to an analog audio signal via digital-to-analog converter 44.

As shown in FIG. 4, effects engine 26 may also perform manipulation 400 whereby the frequency content and audio features of stored digital audio files may be used to alter or manipulate the digital input signal to form manipulated digital signal (step 416). As shown in FIG. 4, when performing manipulation operation 490, effects engine 26 may perform initial audio feature extraction (step 220) and onset detection (step 222) to determine if received digital input signal (step 200) contains a musical event. If an onset is detected in step 222 effects engine 26 may perform frequency analysis (step 204). In frequency analysis (step 204) and audio feature extraction (step 220), a Fourier analysis, using a fast Fourier transform (FFT) or SFFT, of the digital input signal may be performed to convert the digital input signal from the time domain to the frequency domain. This conversion results in a collection of frequency ranges, or bins, and values that correspond to the level of activity in each bin. A collection of frequency domain audio features are extracted including spectral rolloff, spectral flux, and spectral centroid. Further in frequency analysis (step 204), effects engine 26 determines the dominant frequencies

In addition, in manipulation 400, the extracted frequency information is applied to a single stored digital audio file in frequency analysis 204. Digital input signal 21 and the stored digital audio file 480 are passed into frequency analysis process 204, separately, so that the effects engine has access to the frequency information of both the stored digital audio file and digital input signal 21. The main difference between these processes is that the digital audio file only needs to be accessed once because the stored digital audio file is a pre-recorded audio file and not a continuously changing signal. The frequency information extracted from digital input signal 21 acts as a filter to the stored digital audio file. Specifically, frequency information is stored as numeric values in a number of “bins.” Bins are to be understood as frequency ranges that split up the frequency spectrum. The values stored in the bins represent the amplitude of those frequencies within digital input signal 21. The frequency information of digital input signal 21 may be processed continuously at a rate lower than the set sampling rate, for instance, when limitations of speed and processing power are present. As the frequency information is extracted from digital input signal 21, the amplitude of each bin may be multiplied by the corresponding bin in the frequency information of the selected stored digital audio file.

The stored digital audio file frequency information may be accessed and applied. As digital input signal 21 is processed, the position of the stored digital audio file frequency information is updated in relation to digital input signal 21, forming manipulated digital signal (step 416). When multiplying, the bin values may be stored in a data array that is then transformed back into the time-domain by an inverse fast Fourier transform (IFFT) in transform manipulated signal (step 418) so that the manipulated signal can be sent to the digital to analog converter and output as an audio signal.

Triggering and/or manipulation may also perform more complicated re-synthesis which may create more complex relationships between the input audio signal and one or more stored digital audio files. Effects engine 26 may select portions of one or more stored digital audio files, both in the time and frequency domains, to combine and mix to create new sounds triggered and manipulated by the pitch information of digital input signal to form the manipulated digital signal.

Triggering and/or manipulation may also offer other effects to the user, including frequency modulation (FM) or amplitude modulation (AM), where the frequency or amplitude of the digital input signal is modulated by the frequency or amplitude of the stored digital audio file or where the frequency or amplitude of stored digital audio file is modulated by the frequency or amplitude of digital input signal to form the manipulated digital signal.

Unlike traditional methods in which MIDI is used, sampler 110 does not convert audio to MIDI for triggering MIDI enabled sounds. Rather, as described above, sampler 110 extracts pitch information from an audio signal in the frequency domain and then uses that pitch information to manipulate the digital input signal using pre-recorded audio samples. As a result, sampler 110 is not limited to instruments that can work with a MIDI pickup. Further, sampler 110 offers more ways of utilizing the frequency information of both the incoming audio signal and that of the pre-recorded audio samples to create new sounds that are not possible with MIDI. Further, sampler 110 allows a performer to select specific frequency information that exists on a spectrum, ranging from discrete pitches to multiple bands of different frequencies. Most instruments do not create pure pitches consisting of a single frequency, but instead create a series of harmonic and inharmonic frequencies determined by the many factors of the instrument itself, for example, the shape, material, and sound creating mechanism of the instrument. While MIDI pickups are focused on discrete pitch detection, sampler 110 allows performers to use the full range of rich harmonics that the performers' instruments produce as the input for manipulation. Sampler 110 allows traditional instrumentalists to explore sounds and develop new techniques for manipulating audio samples using their preferred instrument, and allow more than simply triggering samples, as with MIDI.

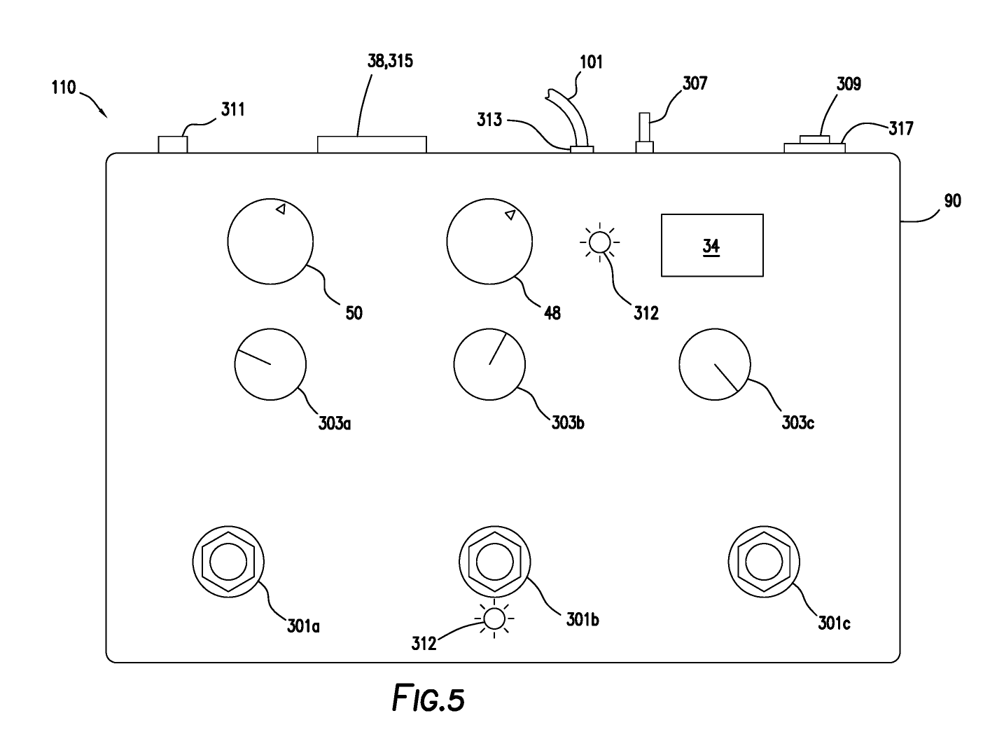

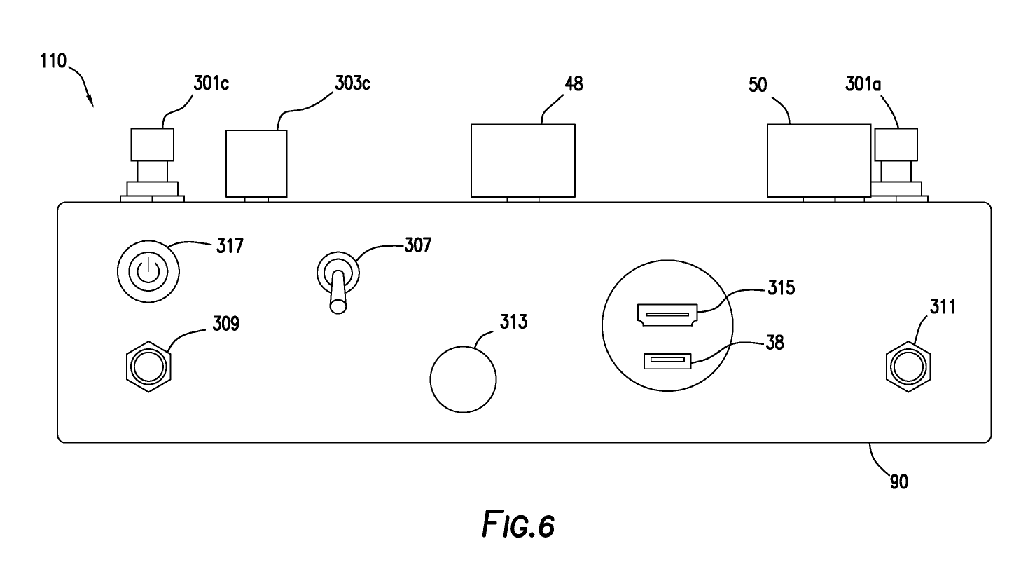

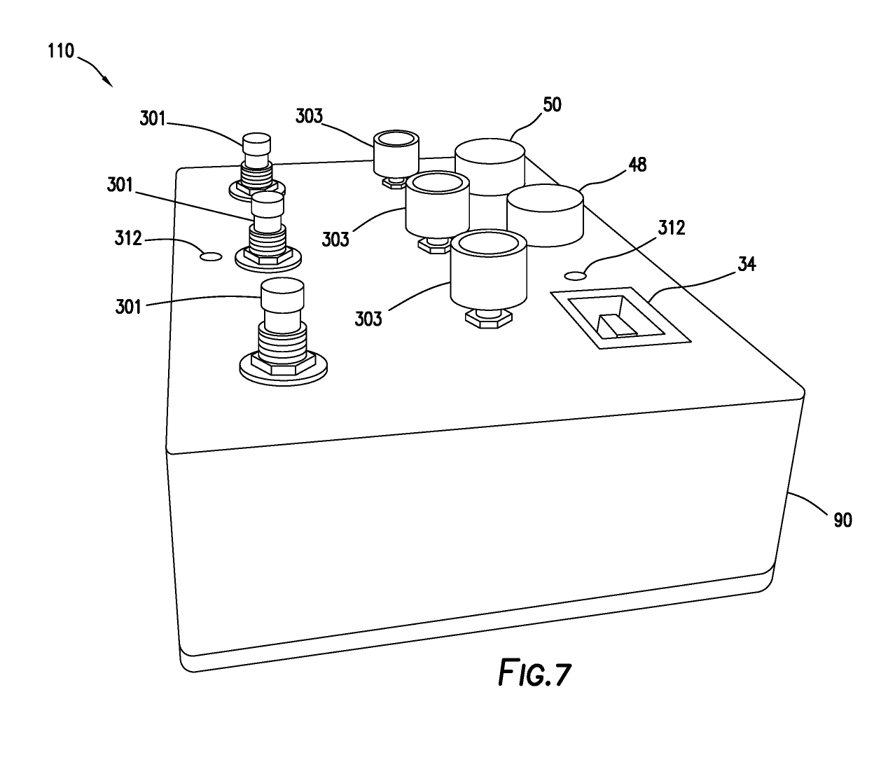

FIGS. 5-7 depict views of sampler 110 consistent with embodiments of the present disclosure. As discussed above, sampler 110 may include enclosure 90. Enclosure 90 may house the electronic components of sampler 110 and may provide a structure for human interface devices including, for example and without limitation, one or more displays 34, push-buttons or foot switches 301a-c, encoders 303a-c, potentiometers 50 and 48, switches 307, one or more audio jacks such as input jack 311 and output jack 309. In some embodiments, enclosure 90 may include power input 313 positioned to receive electrical power from power conduit 101. In some embodiments, enclosure 90 may include power button 317 positioned to allow a user to turn on or off sampler 110.

In some embodiments, switches 301a-c, encoders 303a-c, potentiometers 50 and 48, and switch 307 may be used to control the functionality of sampler 110 as described above through user interface application 30. For example and without limitation, switches 301a-c, encoders 303a-c, and switch 307 may be used to change between different modes of operation of sampler 110 and may change different parameters of the selected mode of operation of sampler 110. In some embodiments, encoders 303a-c may provide input through both rotation of encoders 303a-c and by pushing encoders 303a-c. In some embodiments, switch 307 may be a multiple-position switch such as, for example and without limitation, a 3 pole switch, rocker, or other switch allowing switch 307 to provide multiple inputs. The functions of one or more of switches 301a-c, encoders 303a-c, potentiometers 50 and 48, and switch 307 may vary based on the operating mode of sampler 110 as further described below.

In some embodiments, lights may be used to visually indicate to a user the state of operation of sampler 110 including, for example and without limitation, whether sampler 110 is on or off, whether switch 14 is open or closed, or information relating to the operating mode of sampler 110. In some embodiments, lights 312 may use different colors to indicate different operational states.

In some embodiments, one of switches 301a-c may correspond to switch 14 as discussed above. For example, in some embodiments push-button 301b may correspond to switch 14 and thereby allow a user to select a bypass mode while using sampler 110. In some embodiments, input jack 311 may be audio input device 12, and output jack 309 may be audio output device 52 as discussed above.

In some embodiments, USB port 38 may be coupled to enclosure 90 such that USB port 38 is accessible from outside of enclosure 90. In some embodiments, sampler 110 may include external display port 315 coupled to and accessible from outside of enclosure 90. External display port 315 may, for example and without limitation, allow an external display to be coupled to sampler 110. In such an embodiment, the external display may be used to display a user interface to a user for use during operation and manipulation of the parameters of sampler 110 as discussed above in addition to display 34 of sampler 110.

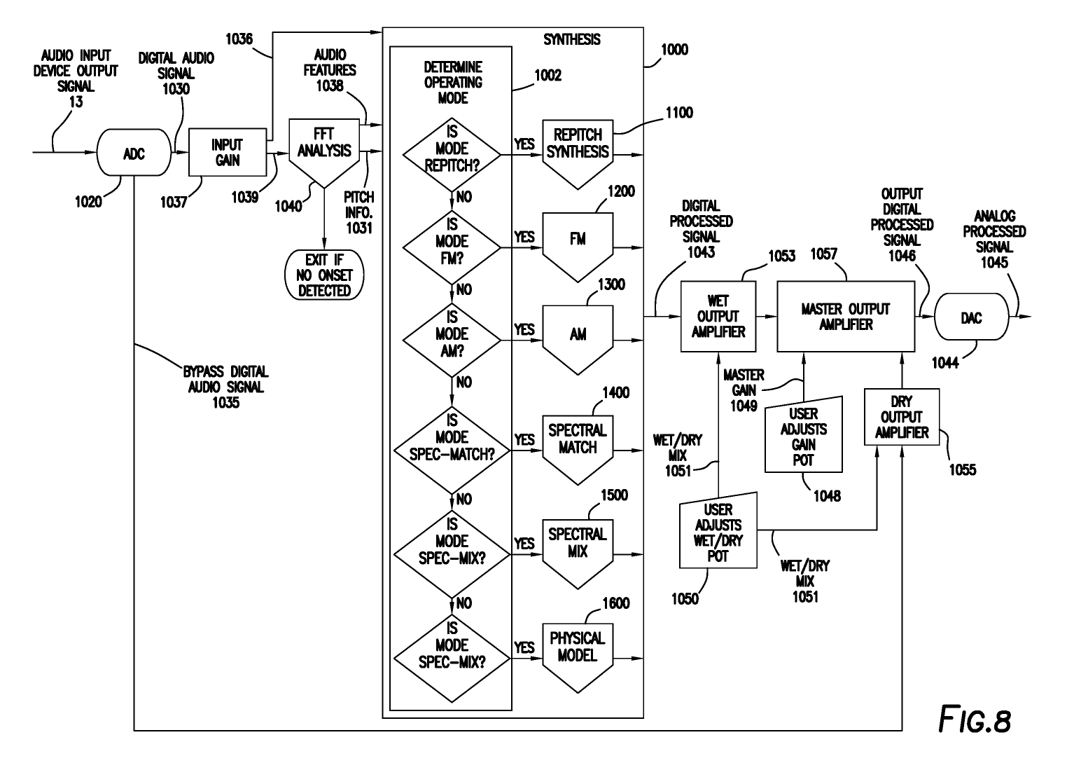

In some embodiments, sampler 110 may be operable in one or more audio synthesis modes selectable by a user as shown in FIG. 8. In some embodiments, one or more of the input devices may be used to allow a user to select a mode for sampler 110. For example and without limitation, push-button 301c may be used to cycle to the next mode while switch 301a may be used to cycle to a previous mode. The selected mode and parameters of the selected mode may be indicated to a user with display 34.

For example and without limitation, in some embodiments, sampler 110 may be operated in one or more of Repitch mode, FM Synthesis mode, AM Synthesis mode, Spectral Match mode, Spectral Mix mode, and Physical Model mode, as described further below. In each operating mode, manipulation 400 of the digital audio signal as discussed above may operate according to a predetermined manipulation function, shown as synthesis 1000. The analog audio input is fed to analog-to-digital converter 1020 as discussed above with respect to analog-to-digital converter 20, to output a digital audio signal, shown as digital audio signal 1030 and bypass digital audio signal 1035. In some embodiments, digital audio signal 1030 may be amplified by gain input 1037 to form gain-adjusted digital audio signal 1036 and FFT analysis input signal 1039. FFT analysis input signal 1039 may be passed to FFT analysis 1040 and gain-adjusted digital audio signal 1036 may be passed to synthesis 1000. Onset and pitch detection are carried out at FFT Analysis 1040 as described herein above to detect pitch information 1031 once onset is detected and pitch information 1031 and frequency domain audio features 1038 from FFT analysis 1040 are passed to synthesis 1000 where, depending on the selected operating mode of sampler 110, digital audio signal 1030 is used to generate digital processed signal 1043. Digital processed signal 1043 may be further manipulated as further described below to form output digital processed signal 1046. Output digital processed signal 1046 may be output through DAC 1044 to generate analog processed signal 1045.

In some embodiments, the position of wet/dry blend control potentiometer 50 as discussed above, may determine the blend between digital processed signal 1043 and bypass digital audio signal 1035. In some such embodiments, the position of wet/dry blend control potentiometer 50 (shown at “User Adjusts Wet/Dry Pot” 1050) may be determined as wet/dry mix 1051. Wet/dry mix 1051 may be used to control the amplification level of wet output amplifier 1053 and dry output amplifier 1055 such that the amplitudes of each signal are blended according to wet/dry mix 1051. In some embodiments, the outputs of wet output amplifier 1053 and dry output amplifier 1055 may be blended at master output amplifier 1057 to form output digital processed signal 1046. In some embodiments, the gain of output digital processed signal 1046 may be adjusted based on the position of potentiometer 48 as discussed above (shown at “User Adjusts Gain Pot” 1048). In some such embodiments, the position of potentiometer 48 may be determined as master gain 1049, which may be used to control the amplification level of master output amplifier 1057 to form output digital processed signal 1046.

In some embodiments, synthesis 1000 may initially determine the operating mode of sampler 110, shown at 1002. Depending on the operating mode of sampler 110, gain adjusted digital audio signal 1036, frequency domain audio features 1038 and pitch information 1031 from FFT analysis 1040 and gain input 1037 are manipulated by a corresponding operation such as, for example and without limitation, repitch synthesis operation 1100, FM synthesis operation 1200, AM synthesis operation 1300, spectral match operation 1400, spectral mix operation 1500, and physical model operation 1600, each further described below.

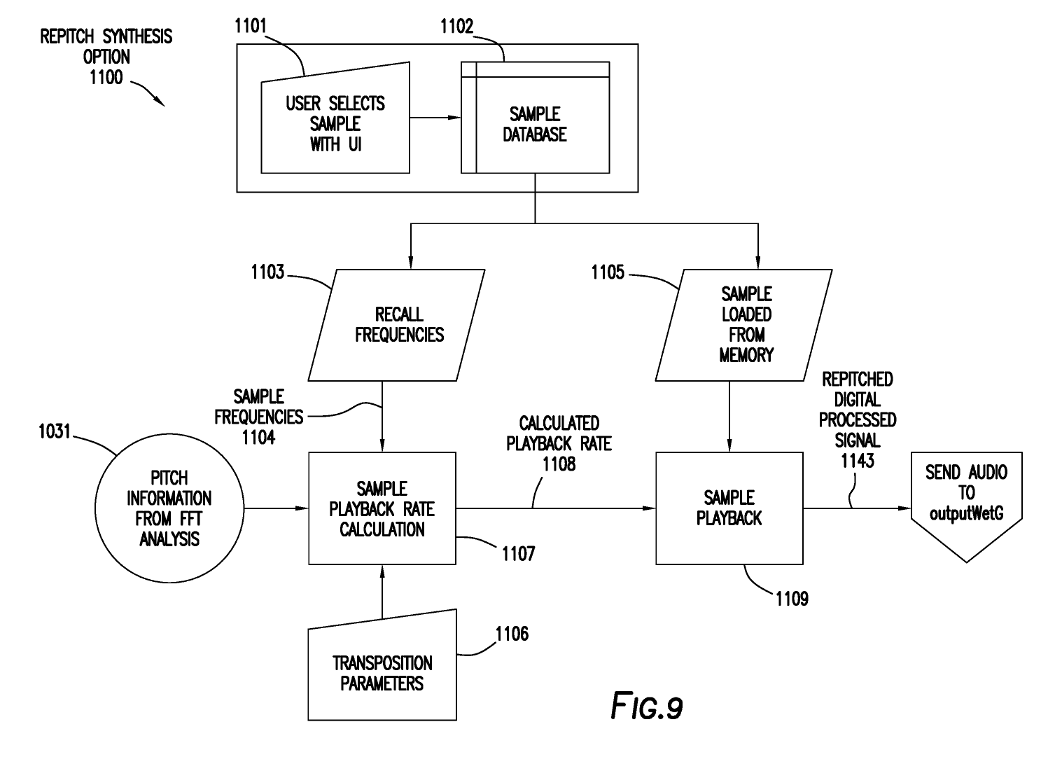

For example, FIG. 9 depicts repitch synthesis operation 1100 used when sampler 110 is in Repitch Mode. In such a mode, the detected pitch of digital audio signal 1030 is used to repitch a stored sample such that the sample is played back at the same pitch as digital audio signal 1030. In repitch synthesis operation 1100, a user may select a sample 1101 from the sample database at 1102. The frequencies of the sample 1104 may be recalled from information stored in the database at recall frequencies 1103, and the sample itself may be loaded from memory at 1105. A playback rate for the sample may be calculated at 1107 based on a comparison of pitch information 1031 from FFT analysis 1040, user defined transposition parameters 1106, and the frequencies of the sample 1104 such that when the sample is played back at the calculated playback rate 1108, the pitch of the sample corresponds to pitch information 1031 of digital audio signal 1030 according to the rules set by the user defined transposition parameters 1106. The sample loaded at 1105 is then played back at 1109 at the calculated playback rate 1108 to output repitched digital processed signal 1143, which may act as digital processed signal 1043.

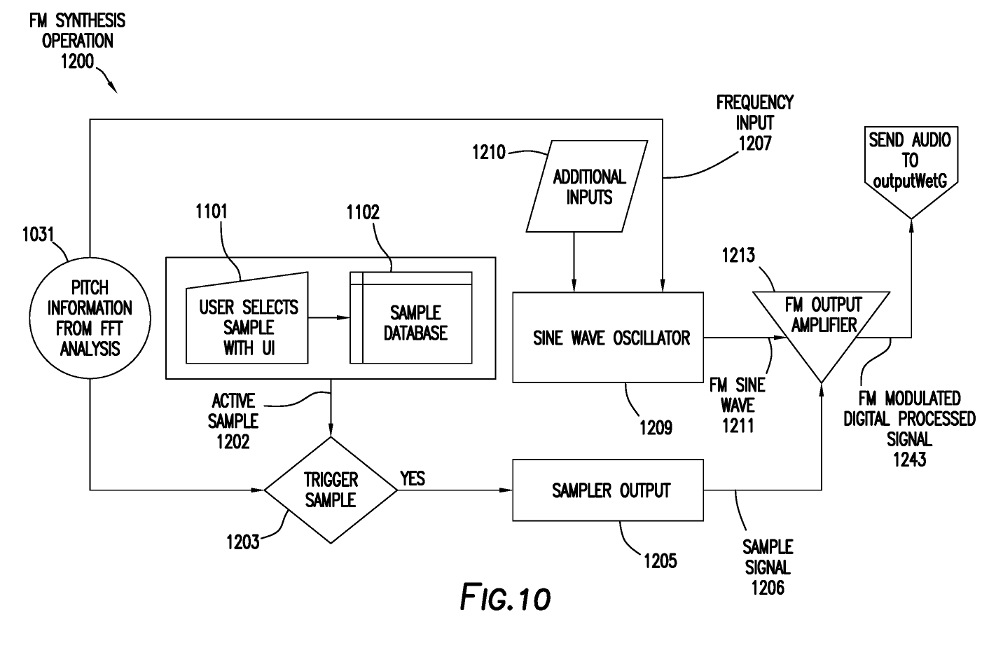

FIG. 10 depicts FM synthesis operation 1200 used when sampler 110 is in FM Synthesis Mode. In such a mode, the detected pitch of the incoming audio signal is used to set the frequency of a sine wave oscillator that acts as a modulator to a sample that is played back as the carrier thereof. In FM synthesis operation 1200, a user may select sample 1101 from sample database 1102 to act as active sample 1202. Playback of active sample 1202 may be triggered when pitch information 1031 is received from FFT analysis 1040, signifying that onset was detected, at trigger sample 1203. The sample may be played at sampler output 1205 to generate sample signal 1206 once trigger sample 1203 activates. Pitch information 1031 is used as the frequency input 1207, for sine wave oscillator 1209. Sine wave oscillator 1209 may output FM sine wave 1211. In some embodiments, sine wave oscillator 1209 may have further inputs 1210 such as gain and default gain to, for example and without limitation, determine the amplitude of FM sine wave 1211. FM sine wave 1211 may be used to modulate the amplitude of sample signal 1206 at FM output amplifier 1213 to generate FM modulated digital processed signal 1243, which may act as digital processed signal 1043.

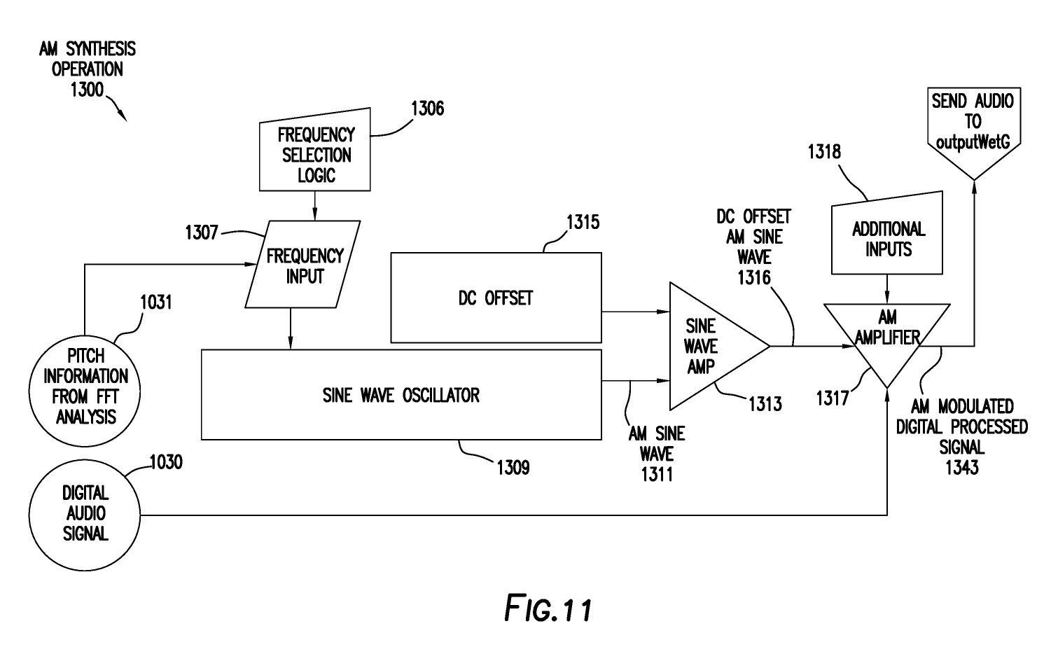

FIG. 11 depicts AM synthesis operation 1300 used when sampler 110 is in AM Synthesis Mode. In such a mode, the detected pitch of the incoming audio signal is used to set the frequency of a sine wave oscillator that acts as a modulator to the amplitude of the incoming audio signal. In such an operation, pitch information 1031 from FFT analysis 1040 is used along with user configurable frequency selection logic 1306 to determine frequency input 1307 for sine wave oscillator 1309. Sine wave oscillator 1309 may output AM sine wave 1311. In some embodiments, AM sine wave 1311 may be combined with a DC offset 1315 by sine wave amplifier 1313 based on a preselected constant to create DC offset AM sine wave 1316. In some embodiments, digital audio signal 1030 may be modulated in amplitude by AM amplifier 1317 at a gain value corresponding to AM sine wave 1311 to generate AM modulated digital processed signal 1343, which may act as digital processed signal 1043. In some embodiments, AM amplifier 1317 may have additional inputs 1318 that may, for example and without limitation, adjust the overall gain of AM amplifier 1317.

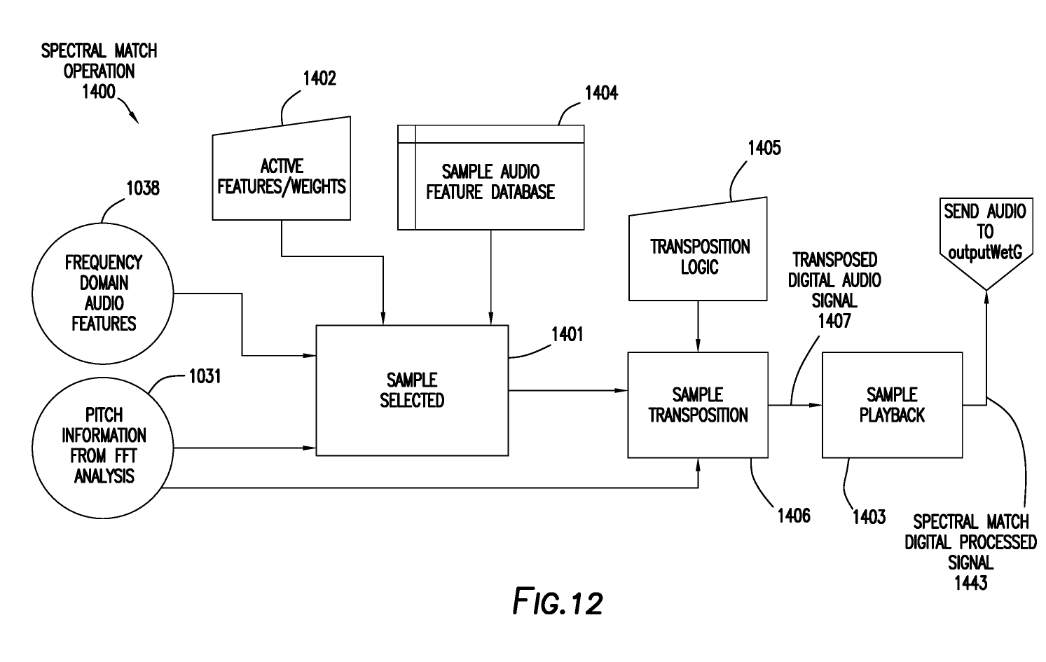

FIG. 12 depicts spectral match operation 1400 used when sampler 110 is in Spectral Match Mode. In such a mode, the spectral properties of the incoming audio signal are used to select a sample for playback. In such an operation, pitch information 1031 and frequency domain audio features 1038 of digital audio signal 1030 are compared to the sample audio feature database 1404. User selected features and weights 1402 are used to calculate the sample that is the closest match to the active audio features of the digital audio signal 1030 at sample selection 1401. The sample that is the closest match may be transposed at sample transposition 1406 according to user selected transposition logic 1405 to create a transposed digital audio signal 1407. Transposed digital audio signal or the signal that is the closest match is then played back at 1403 to generate spectral match digital processed signal 1443, which may act as digital processed signal 1043.

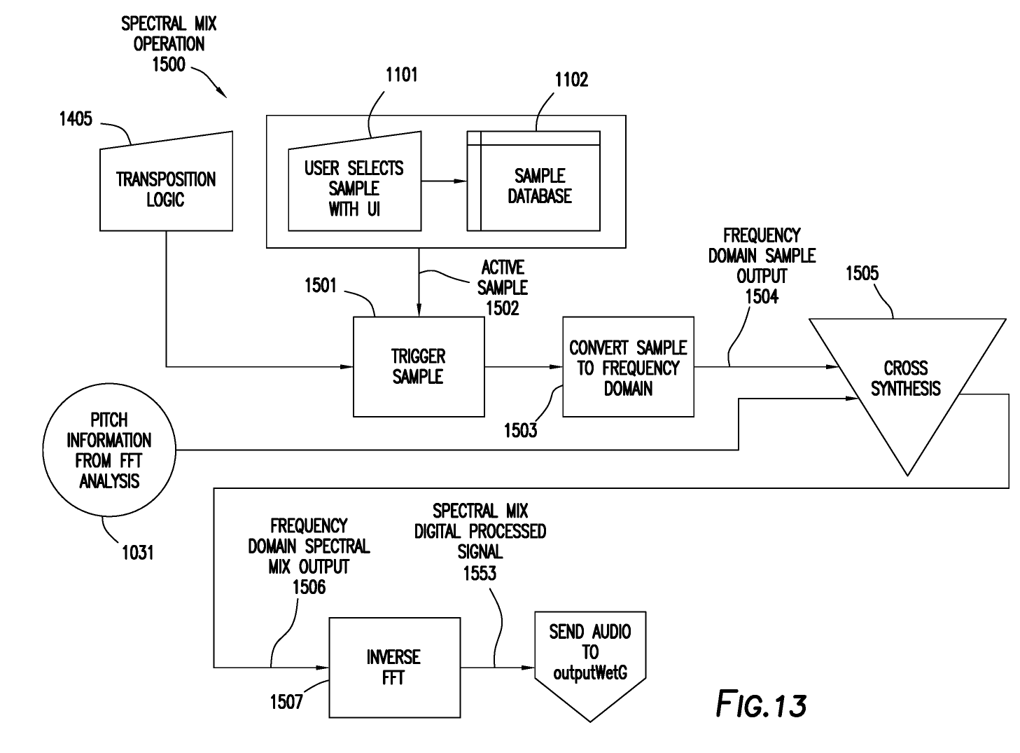

FIG. 13 depicts spectral mix operation 1500 used when sampler 110 is in Spectral Mix Mode. In such a mode, the spectral properties of the incoming audio signal are combined with a sample stored in the sample database, and the spectrally mixed result is output. In such an operation, an active sample 1502 is selected from samples 1101 from sample database 1102. According to user selected transposition logic 1405, active sample 1502 is played back in trigger sample 1501 and passed through an FFT 1503 to output a frequency domain sample output 1504. The magnitude of the FFT bins of pitch information 1031 are transposed onto the frequency magnitude values of frequency domain sample output 1504 at 1505 to generate frequency domain spectral mix output 1506. In other embodiments, the frequency magnitude values of the frequency domain sample output are transposed onto the magnitude of the FFT bins of pitch information 1031. Frequency domain spectral mix output 1506 is then passed through inverse FFT 1507 to generate spectral mix digital processed signal 1553, which may act as digital processed signal 1043.

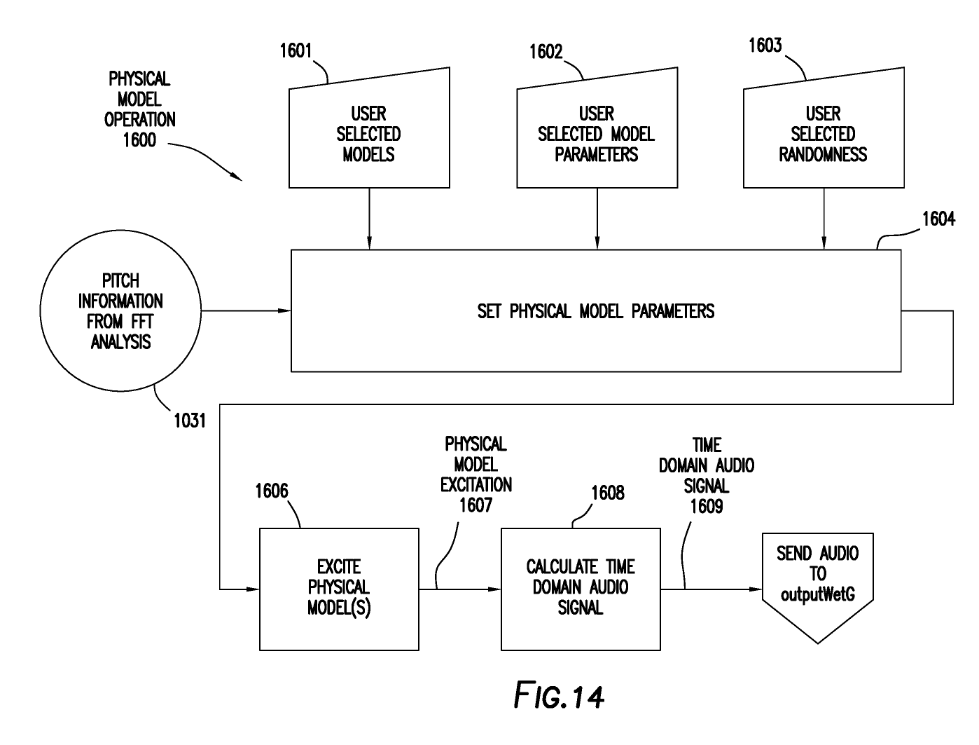

FIG. 14 depicts physical model operation 1600 used when sampler 110 is in Physical Model Mode. In such a mode, pitch information 1031 from FFT analysis 1040 is passed into one or more physical synthesis modules 1604 where user selected model(s) 1601, user selected model parameters 1602 and optionally user selected randomness 1603 are combined. The resulting model with parameters is excited in excite physical model 1606 to create physical model excitation 1607. The time domain audio signal of the physical model excitation is calculated in 1608, resulting in time domain audio signal 1609.

In some embodiments, the functionality of encoders 303a-c and switch 307 may change based on the operating mode of sampler 110.

For example and without limitation, in some embodiments, while sampler 110 is in Repitch Mode, encoder 303a may be used to select a sample for a given pitch range, encoder 303b may be used to select sample playback logic, and encoder 303c may be used to select transposition of pitch information 1031. In some embodiments, switch 307 may be used to control whether the sample is played in forward or reverse depending on the position of switch 307.

In some embodiments, while sampler 110 is in FM Synthesis Mode, encoder 303a may be used to select a sample, encoder 303b may be used to determine a frequency ratio for the modulator when compared with pitch information 1031, and encoder 303c may be used to select the overall gain of the modulator.

In some embodiments, while sampler 110 is in AM Synthesis Mode, encoder 303c may be used to select the mode of modulation frequency logic between a dynamic and static mode. In some such embodiments, encoder 303a may be used to select a dynamic modulation ratio to select the frequency ratio in which pitch information 1031 will be multiplied by to set the frequency of sine wave oscillator 1309. In some such embodiments, encoder 303b may be used to select a static modulation frequency for use while the static mode is selected.

In some embodiments, while sampler 110 is in Spectral Match Mode, encoder 303a may be used to select the primary audio feature the mode will use to pick a sample. The options may be frequency, spectral centroid, spectral roll off, and spectral flux. The mode may cross reference between all samples in the database for a match. in some environments, encoder 303b may be used to select secondary logic parameters, such as if there are multiple samples whose primary features are close to pitch information 1031, sampler 110 will then look to the second feature chosen by encoder 303b to determine which sample to play. In some embodiments, encoder 303c may be used to select the repitch mode between a static mode in which the chosen sample is played back at the normal speed or a dynamic mode in which the sample will be repitched according to pitch information 1031 and the sample's frequency. In some embodiments, switch 307 may be used to control whether the sample is played in forward or reverse depending on the position of switch 307.

In some embodiments, while sampler 110 is in Spectral Mix Mode, encoder 303a may be used to select a sample. In some embodiments, encoder 303b may be used select whether the playback speed of the sample is automatic or static. When in automatic mode, sampler 110 may repitch the sample to closer match pitch information 1031. When in static mode, sampler 110 may play back the sample at normal speed. In some embodiments, encoder 303c may be used to select a mix preference for sampler 110 between input or sample mode. When in input mode, digital audio signal 1030 is given preference, while in sample mode, frequency domain spectral mix output 1506 is given preference in the cross synthesis.

In some embodiments, while sampler 110 is in Physical Model Mode, encoder 303a may be used to select an amount of randomness to be applied to the parameters of the physical model. In some embodiments, encoder 303b may be used to select randomness logic between a static mode in which the physical model parameters are randomly set each time encoder 303a is changed and a dynamic mode in which the physical model parameters are randomly set each time onset is detected. In some embodiments, encoder 303c may be used to select transposition of pitch information 1031. In some embodiments, switch 307 may be used to select between different physical models. For example and without limitation, in some embodiments, switch 307 may select between different instruments including, for example and without limitation, a sitar, modal bar, and mandolin.

In some embodiments, sampler 110 may operate in a Bypass Mode such as, for example and without limitation, when switch 14 is disengaged as described herein above. When in Bypass Mode, sampler 110 may use display 34 to display information relating to the signal such as, for example and without limitation, the pitch detected from the instrument. In some such embodiments, when in Bypass Mode, encoder 303a may be used to determine whether the displayed pitch is quantized to the nearest semi-tone or not. In some embodiments, encoder 303b may be used to select the type of instrument. For example and without limitation, encoder 303b may be used to select between a guitar or bass guitar mode to, for example and without limitation, show preference to identifying lower frequencies when in bass guitar mode. In some embodiments, encoder 303c may be used to save the current settings of sampler 110 or to load previously saved settings. In some embodiments, switch 307 may be used to select whether the pitch information is displayed or not.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A process comprising:
collecting a digital input signal;
performing initial pitch detection to detect one or more pitches on the digital input signal;
manipulating the digital input signal to form a manipulated digital signal based on the one or more pitches detected; and
outputting an audio signal based on the manipulated digital signal.

2. The process of claim 1, wherein the digital input signal is obtained from an analog-to-digital converter.

3. The process of claim 1, wherein the step of performing initial pitch detection comprises:
performing frequency analysis; and
performing pitch detection.

4. The process of claim 3, wherein the step of performing frequency analysis comprises:
using an FFT or SFFT to convert the input digital audio signal from the time domain to the frequency domain, the input digital audio signal in the frequency domain having frequencies;
collecting frequencies into frequency ranges;
determining one or more dominant frequencies for each frequency range if dominant frequencies are present in the frequency ranges; and
determining the pitch corresponding to each of the dominant frequencies.

5. The process of claim 4, wherein following determining the pitch corresponding to the dominant frequencies, if the pitch exists:
executing the step of manipulating the digital input signal.

6. The process of claim 5, wherein the step of manipulating the digital input signal comprises:
mapping a stored digital audio file to the pitch, wherein the identity of the stored digital audio file is dependent upon the pitch detected;
altering the input digital signal using the frequency information of the stored digital audio file; and
selecting portions of the stored digital audio file to combine and mix to create new sounds;
modulating the frequency or amplitude of the digital input signal using the frequency or amplitude of the stored digital audio file.

7. The process of claim 1, further comprising:
performing onset detection to detect an onset in the digital input signal, and if onset is detected, executing the step of performing pitch detection.

8. The process of claim 1, wherein the step of outputting an audio signal comprises:
transforming the manipulated digital signal from the frequency domain to the time domain; and
converting the time domain manipulated digital signal to an audio signal with a digital to analog converter.

9. A method of manipulating an analog signal from an instrument comprising:
accepting an analog audio signal from an instrument through an audio input device;
transmitting the analog audio signal to an analog-to-digital converter to form a digital input signal;
transmitting the digital input signal to a processor;
performing onset detection, pitch detection, and frequency analysis with the processor on the digital input signal;
forming a manipulated digital signal using the processor;
transmitting the manipulated digital signal to a digital-to-analog converter;
converting the manipulated digital signal to an analog processed signal using the digital-to-analog converter;
transmitting the analog processed amp signal to a post-effects device; and
forming an audio output signal using the post-effects device.

10. The method of claim 9, wherein the instrument comprises a stringed instrument, an acoustic instrument, or an effects pedal.

11. The method of claim 9, further comprising transmitting the analog processed signal to an output pre-amp to adjust the output gain or volume of the analog processed signal to form a processed amp signal, wherein the processed amp signal is transmitted to the post-effects device to form the audio output signal.

12. The method of claim 9 further comprising:
transmitting the audio output signal to an audio output device; and
transmitting the audio output signal from the audio output device to an effects pedal, amplifier, or recording device.

13. The method of claim 9, further comprising transmitting the analog audio signal to a pre-amp to form a pre-amp signal output, wherein the pre-amp signal output is transmitted to the analog-to-digital converter.

14. The method of claim 13, wherein the pre-amp includes an operational amplifier and a potentiometer.

15. The method of claim 9, wherein the step of forming the manipulated digital signal comprises sampling.

16. The method of claim 15, wherein sampling comprises:
taking snapshots of the analog audio signal at pre-determined intervals.

17. The method of claim 16, wherein a sampling rate is from 22 to 192 kHz.

18. The method of claim 9, wherein the processor comprises:
a digital storage database stored on non-transitory computer-readable media;
an effects engine; and
a user interface application.

19. The method of claim 18 further comprising receiving input though the user interface application and communicating the input to the effects engine.

20. The method of claim 19 further comprising transmitting input from a user interface to the user interface application.

21. The method of claim 20, wherein the input comprises pitch detection and frequency analysis parameters, instructions for mapping stored digital audio files to pitch, parameters of the analog-to-digital converter; parameters of the digital-to-analog converter, parameters of the style of an output sample manipulation, or combinations thereof.

22. A sampler comprising:
an audio input device;
a switch, the switch in analog communication with the audio input device;
a post-effects device, the post effects device in analog communication with the switch;
a pre-amp, the pre-amp in analog communication with the switch;
an analog-to-digital converter in analog communication with the pre-amp;
a processor, the processor in digital communication with the analog-digital converter;
a digital-to-analog converter in digital communication with the processor and in analog communication with the post-effects device;
an audio output device, the audio output device in digital communication with the post-effects device.

23. The sampler of claim 22 further comprising an enclosure, wherein the audio input device, the switch, the post-effects device, the pre-amp, the analog-to-digital converter, the processor, the digital-to-analog converter, and the audio output device are positioned within the enclosure.

24. The sampler of claim 23, wherein the sampler is adapted to be mounted to a stringed instrument or other acoustic instrument.

25. The sampler of claim 24, wherein the sampler is a foot pedal.

26. The sampler of claim 23, further comprising at least one of a switch, push-button, encoder, potentiometer, and display mounted to the enclosure.

27. The sampler of claim 22, wherein the audio input device is a ¼ inch jack, an audio jack, a Tiny Telephone, an XLR, or an optical jack.

28. The sampler of claim 22, wherein the switch is a latched switch.

29. The sampler of claim 28, wherein the switch is a three pole double throw switch, a double pole double throw switch, or a momentary open push-button foot switch.

30. The sampler of claim 22, wherein the audio output device is a ¼ inch jack, an audio jack, a Tiny Telephone, an XLR, or an optical jack.

31. The sampler of claim 22, wherein the sampler further comprises a user input device.

32. The sampler of claim 31, wherein the user input device is a touch screen, keyboard, joystick, or mouse.

33. The sampler of claim 22, wherein the post-effects device includes a wet/dry control blend potentiometer, an op-amp, and a potentiometer.
